(19) United States
(12) Patent Application Publication
(10) Pub. No.: US 2016/0268814 A1
(43) Pub. Date: Sep. 15, 2016

(54) WIRELESS POWER TRANSFER FOR MOBILE DEVICES

(71) Applicant: WiTricity Corporation, Watertown, MA (US)

(72) Inventors: Alexander P. McCauley, Sunnyvale, CA (US); Yi Xiang Yeng, Cambridge, MA (US); Dustin J. Alinger, Boston, MA (US)

(21) Appl. No.: 15/068,693

(22) Filed: Mar. 14, 2016

Related U.S. Application Data
(60) Provisional application No. 62/133,089, filed on Mar. 13, 2015.

(51) Int. Cl. H02J 5/00; H02J 50/12; H04B 5/00

(52) U.S. Cl. CPC H02J 5/005; H04B 5/0037; H02J 50/12

(57) ABSTRACT

The disclosure features wireless power receiver modules for computing systems. The wireless power receiver modules can include a receiver resonator that can include an inductor formed substantially in a first plane. The receiver resonator can be configured to capture oscillating magnetic flux. The modules can include a planar piece of metallic material formed in a second plane. The planar piece of metallic material can define an aperture in which the inductor of the receiver resonator is disposed. The planar piece of metallic material can define first and second breaks extending from an outer edge of the planar piece of metallic material to the aperture to form first and second portions of the planar piece of metallic material.

### CROSS-REFERENCE TO RELATED APPLICATIONS

This application incorporates herein by reference and claim priority to U.S. Provisional Patent Application No. 62/133,089 filed Mar. 13, 2015 and entitled “WIRELESS POWER TRANSFER FOR MOBILE DEVICES.”

### FIELD

The field of this invention relates to wireless power transfer.

### BACKGROUND

Energy can be transferred from a power source to receiving device using a variety of known techniques such as radiative (far-field) techniques. For example, radiative techniques using low-directionality antennas can transfer a small portion of the supplied radiated power, namely, that portion in the direction of, and overlapping with, the receiving device used for pick up. In this example, most of the energy is radiated away in all the other directions than the direction of the receiving device, and typically the transferred energy is insufficient to power or charge the receiving device. In another example of radiative techniques, directional antennas are used to confine and preferentially direct the radiated energy towards the receiving device. In this case, an uninterruptible line-of-sight and potentially complicated tracking and steering mechanisms are used.

Another approach is to use non-radiative (near-field) techniques. For example, techniques known as traditional induction schemes do not (intentionally) radiate power, but uses an oscillating current passing through a primary coil, to generate an oscillating magnetic near-field that induces currents in a near-by receiving or secondary coil. Traditional induction schemes can transfer modest to large amounts of power over very short distances. In these schemes, the offset tolerance offset tolerances between the power source and the receiving device are very small. Electric transformers and proximity chargers are examples using the traditional induction schemes.

### SUMMARY

In a first aspect, the disclosure features wireless power receiver modules for computing systems. The wireless power receiver modules can include a receiver resonator that includes an inductor formed substantially in a first plane and is configured to capture oscillating magnetic flux and a planar piece of metallic material formed in a second plane. The planar piece of metallic material defines an aperture in which the inductor of the receiver resonator is disposed and the planar piece of metallic material defines first and second breaks extending from an outer edge of the planar piece of metallic material to the aperture to form first and second portions of the planar piece of metallic material.

Embodiments of the modules can include any one or more of the following features. The metallic material can include copper. The planar piece of metallic material can define a third break from the outer edge to the aperture. The planar piece of metallic material can define a fourth break from the outer edge to the aperture. The wireless power receiver modules can include a layer of magnetic material disposed between a surface of the inductor and the computing system. The layer of magnetic material can extend beyond an outer perimeter of the inductor. The layer of magnetic material can extend to the outer edge of the planar piece of metallic material. The computing systems can be a laptop, notebook computer, tablet, or mobile phone. The planar piece of metallic material can form a back cover of the computing system.

The aperture can be rectangular with four edges with four midpoints and the breaks in the planar piece of metallic material can be formed at the four midpoints. The breaks in the planar piece of metallic material can be formed at an angle to the aperture. The planar piece of metallic material can enhance coupling between the receiver resonator and a source resonator configured to generate an oscillating magnetic field when the receiver resonator is positioned over the source resonator. The thermal interface material can be positioned in the breaks of the planar piece of metallic material. The first plane and second plane can be coplanar.

The breaks in the planar piece of metallic material can have a width equal to or greater than 0.05 mm. The first portion can confine a first eddy current and the second portion can confine a second eddy current when the module is positioned near a wireless power source.

Embodiments of the modules can also include any of the other features disclosed herein, including features disclosed in connection with different embodiments, in any combination as appropriate.

In another aspect, the disclosure features methods including forming a first break and a second break in a planar piece of metallic material such that the first and second breaks extend from an outer edge of the planar piece of metallic material to an aperture defined in the planar piece of metallic material. The planar piece of metallic material can be in a first plane and the first and second breaks form a first portion and a second portion of the planar piece of metallic material. The methods can include disposing an inductor of a receiver resonator in the aperture in a second plane.

Embodiments of the methods can include any one or more of the following features.

The methods can include forming a third break in the planar piece of metallic material such that the third break extends from the outer edge to the aperture. The methods can include forming a fourth break in the planar piece of metallic material such that the fourth break extends from the outer edge to the aperture. The first portion can confine a first eddy current and the second portion can confine a second eddy current when the module is positioned near a wireless power source.

As used herein, a “break” in a metallic material means a break in the continuity of the metallic material and can be formed, for example, by placing two pieces of metallic material next to one another with a gap in between.

Embodiments of the methods can also include any of the other features disclosed herein, including features disclosed in connection with different embodiments, in any combination as appropriate.

### BRIEF DESCRIPTION OF DRAWINGS

FIG. 1A shows an diagram of an exemplary embodiment of a wireless power transfer system for a computing device. FIG. 1B shows an exemplary embodiment of a wirelessly powered computing device on a wireless power source.

FIG. 2A shows a model of an exemplary embodiment of a back cover of a computing device without any breaks. FIG. 2B shows a model of an exemplary embodiment of a back cover of a computing device with two breaks.

FIG. 3 shows a model of an exemplary embodiment of a wireless power system for a computing device.

FIGS. 4A-4B show simulations of an exemplary embodiment of a source and back cover without breaks.

FIGS. 5A-5B show simulations of an exemplary embodiment of a source and back cover with breaks.

FIGS. 6A-6D show models of exemplary embodiments of back covers for a computing device.

FIGS. 7A-7B show models of exemplary embodiments of back covers for a computing device.

FIGS. 8A-8C show cross-sectional views of exemplary embodiments of wirelessly charged computing devices.

### DETAILED DESCRIPTION

Various aspects of wireless power transfer systems are disclosed, for example, in commonly owned U.S. Patent Application Publication No. 2012/0119569 A1, U.S. Patent Application Publication No. 2013/0200721 A1, and U.S. Patent Application Publication 2013/0033118 A1, U.S. Patent Application Publication 2013/0057364 A1, the entire contents of which are incorporated by reference herein.

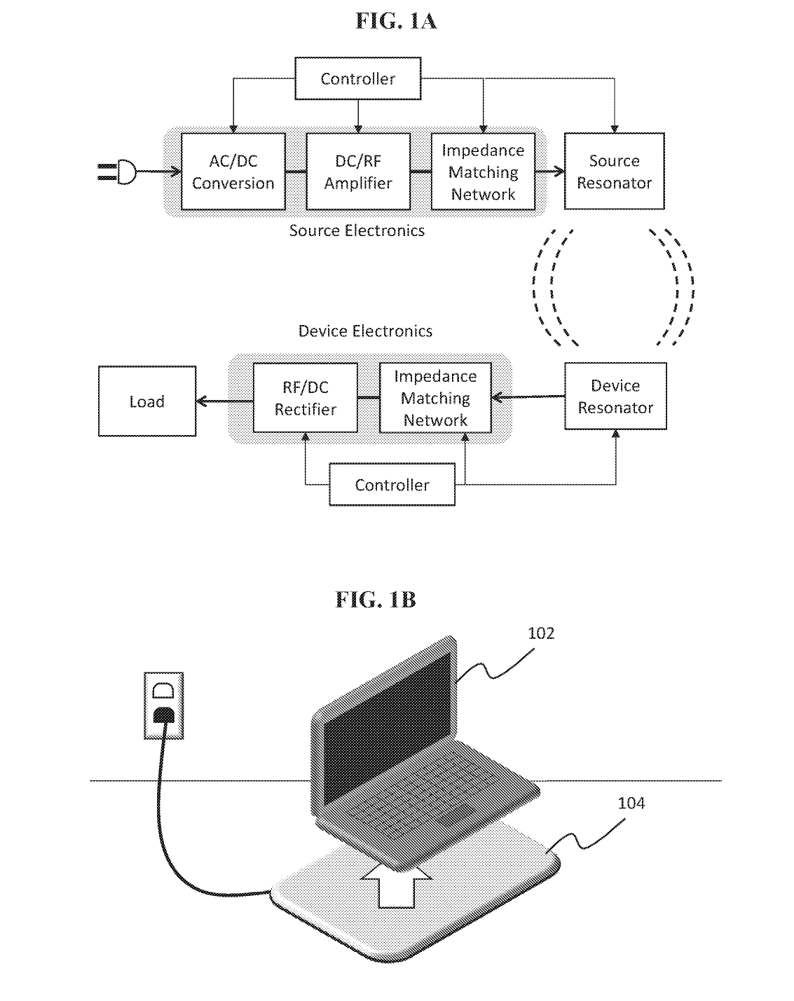

FIG. 1A shows an diagram of an exemplary embodiment of a wireless power transfer system for a computing device, such as a laptop. A wireless power transfer system may transfer power to directly power a computing device or to charge a battery of the computing device. A computing device may be a laptop, notebook computer, tablet, phablet, mobile phone, smartphone, and the like. A wireless power transfer system may include a source that draws power from a power supply such as AC mains, battery, solar cell, and the like. The source may include electronics to convert power from the power supply, an amplifier, an impedance matching network, and one or more controllers that may interface with any component of the source-side system. The source also includes a source resonator that includes an inductor and a capacitance that is driven by the source electronics to generate an oscillating magnetic field by which to transfer energy to a device. In embodiments, the source resonator may be a high-Q resonator. In embodiments, the quality factor of the high-Q resonator may be greater than 100. A current may be generated in the device resonator, which also includes an inductor and a capacitance. The energy received via the device resonator can be transferred to a load. For example, the load can be the computing device itself or a battery of the computing device. The device electronics may include a matching network, rectifier, one or more controllers, and the like. In exemplary embodiments, the device resonator may be a high-Q resonator. In embodiments, the high-Q resonator may have a quality factor of greater than 100. In exemplary embodiments, the source may include multiple source resonators. In exemplary embodiments, the device may include multiple device resonators. FIG. 1B shows an exemplary embodiment of a wirelessly powered computing system, for example a laptop 102, on a wireless power source 104. The laptop may be positioned on, over, near, or next to a source 104. In exemplary embodiments, the source may in the form of a pad on a surface, such as a table, or under a surface. The end-to-end efficiency can be greater than 30%, 50%, 70%, 75%, 80%, 90%, or 95%. In embodiments, the device can provide 1 W, 2.5 W, 5 W, 10 W, 20 W, 30 W, 50 W, or more to the load (for example, battery of a mobile phone or laptop). For example, a source may be able to transmit at least 20W of power to a laptop battery with at least 70% end-to-end efficiency. In another example, a source may be able to transmit at least 5W of power to a phone battery with at least 60% end-to-end efficiency. In embodiments, the operating frequency of wireless power transmission is 50 to 300 kHz, 6.78 MHz, or any Industrial, Scientific, Medical (ISM) band frequency.

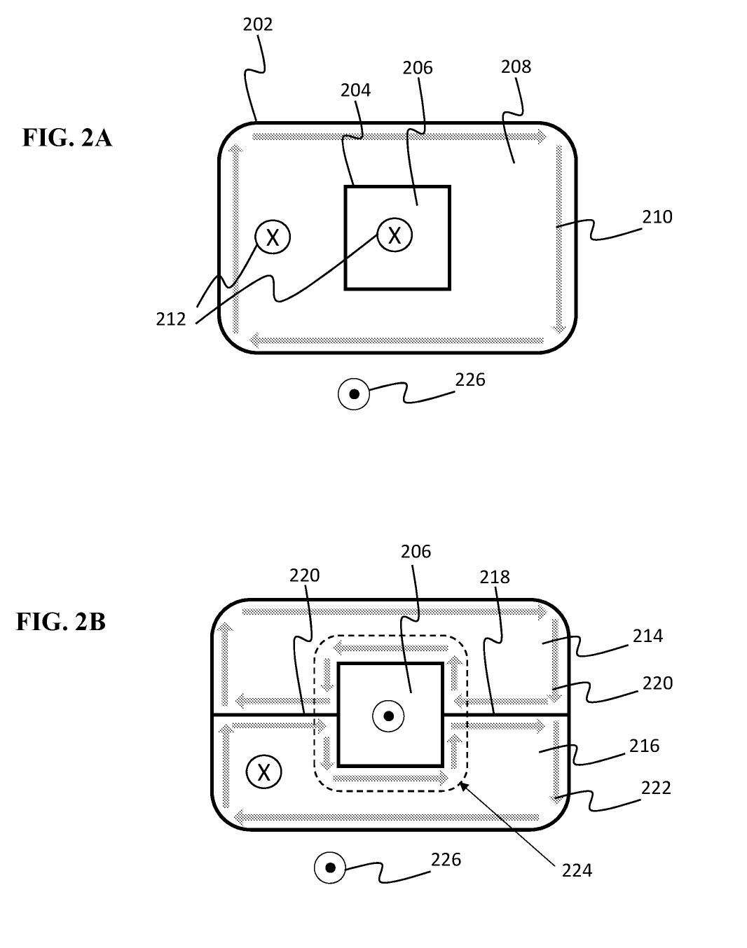

In exemplary embodiments, it may be challenging to transfer power via a magnetic field to computing devices such as laptops, tablets, and mobile phones due to the use of metallic materials in the construction. Metallic materials can include metals, such as aluminum and copper, as well as metal alloys, such as magnesium alloys, steel, aluminum alloys, and the like. For example, a computing device may have a back cover that may be most exposed to a source's magnetic field (as shown in FIG. 1B). The back cover, if made of metallic materials, such as a magnesium allow, may be lossy due to the eddy currents that are induced. Losses in metallic materials will result in a lower efficiency of wireless power transfer. Eddy currents will form to oppose the magnetic field of the source. Thus, for a given time interval, the current of the source resonator and eddy current will flow in opposite directions. A given time internal may be an instantaneous “snapshot” of the oscillating magnetic field. FIG. 2A shows the net result of eddy currents flowing in a back cover of a computing device 208. The net resulting eddy currents 210 will flow along the outer edge 202 of the back cover 208. The outer edge 202 extends around the entire outer perimeter of the back cover 208. Another example of this can be seen in FIG. 2B, where the back cover of the computing device is broken into two continuous pieces. Here, instead of flowing on the overall outer edge of the back cover, the eddy currents 220, 222 will flow via the lower impedance path which is along the breaks 220 and 218 of back cover. Note that for a source magnetic field 226 pointing out of the page, the eddy currents will create a magnetic field 212 (into the page) to oppose.

FIG. 2A-FIG. 2B show models of exemplary embodiments of back covers of a wirelessly charged computing system. In both embodiments, the outer edge 202 of the back cover is shaped to follow the form factor of a bottom surface of a laptop, tablet, mobile phone, and the like. The inner edge 204 of the back cover is shaped to form a hole or aperture for the shape 206 of a device resonator coil 206 to fit into. FIG. 2A shows a back cover made of a continuous piece 208 of magnesium alloy. When a source (not shown) generates a magnetic field, both a current in the device resonator coil and eddy currents 210 in the back cover 208 are induced. The eddy currents 210 shown are generally concentrated at the outer edge of the back cover and, for a given time interval, may flow in the clockwise fashion to oppose the source's magnetic field (B-field) pointing into the page 212. FIG. 2B shows a back cover made of two continuous pieces 214 and 216 of magnesium alloy. Breaks 218 and 220 form these two continuous pieces 214, 216 that define a hole or aperture for the shape 206 of a device resonator coil to fit into. In exemplary embodiments, the breaks in the back cover may be equal to or greater than 0.05 mm, 0.1 mm, 0.5 mm, 1 mm or greater. In embodiments, the breaks 218 and 220 can be formed at various locations along the outer edge and inner edge. The eddy currents 220, 222 that form in the two continuous pieces 214 and 216 are generally concentrated at the outer edge of each of the two pieces. Due to the shapes of the two pieces forming the aperture in which the resonator coil is placed, the eddy currents flow opposite to one another. In other words, eddy currents 220 flow opposite in direction to eddy currents 222. This creates an overall effect of eddy currents flowing in the shape shown in dotted lines 224. An advantage of this created effect is that the coupling between the source resonator and device resonator is enhanced.

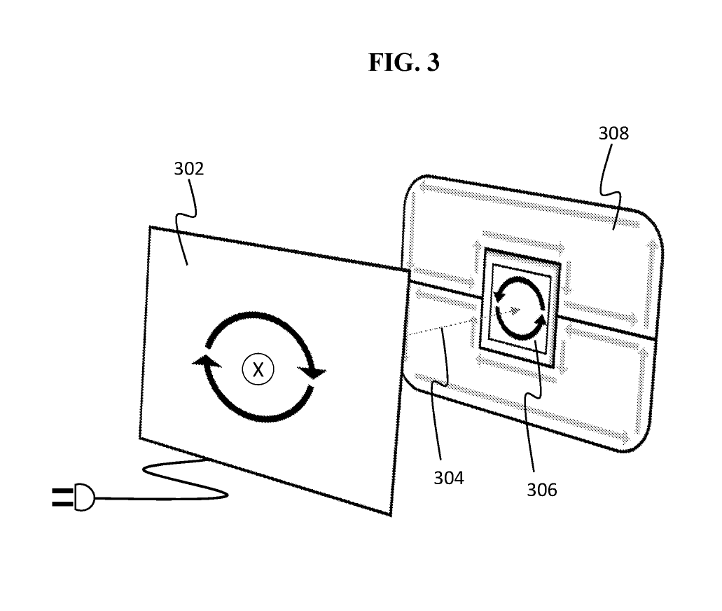

FIG. 3 shows a model of an exemplary embodiment of a wireless power transfer system for a computing device. The system is shown at an angle to be able to view the direction of the currents generated in the various components of the system for an instantaneous time interval. The source 302 includes a source resonator (not shown) having a current flowing in clockwise direction for an instantaneous time interval, generating a magnetic field with a dipole moment 304 out of the plane of the source 302. As the device resonator sits in the magnetic field of the source, a current is generated in the device resonator. The current may be in a clockwise direction for the same instantaneous time interval. Also generated by the presence of the magnetic field are eddy currents in the back cover 306 of the computing system. The example of the configuration of the back cover 308 is that shown in FIG. 2B.

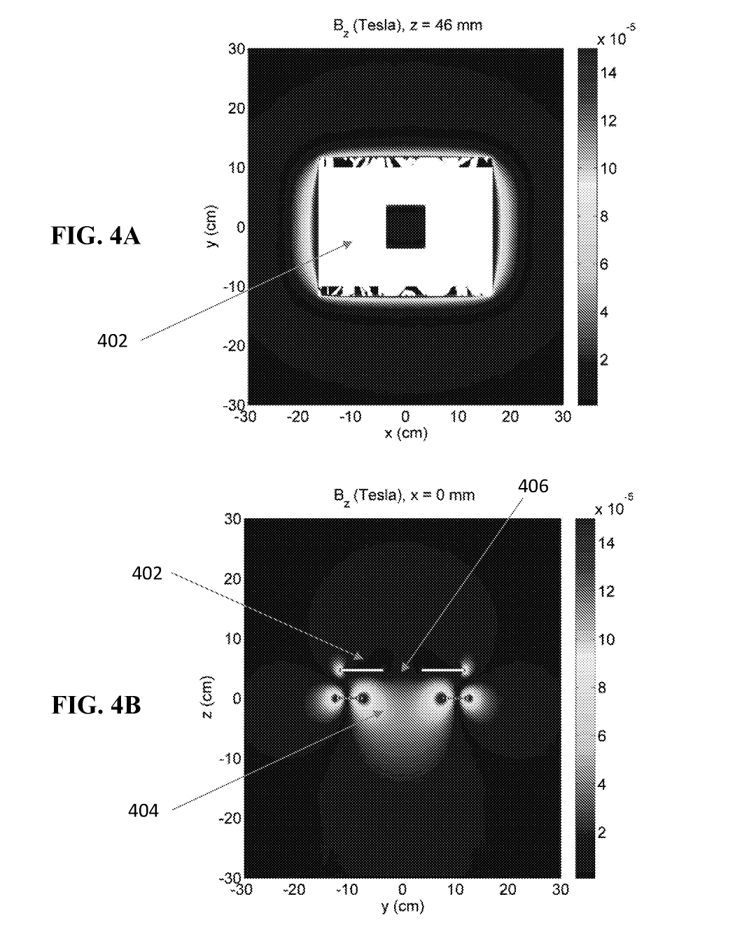

FIGS. 4A-4B show simulations of an exemplary embodiment of a back cover near a source. The back cover shown in this example uses the properties of aluminum and is one continuous piece (similar to that shown in FIG. 2A). FIG. 4B shows a cross-sectional view of the back cover shown in FIG. 4A. As shown in FIG. 4B, due to the opposing eddy currents generated in the back cover 402, the source magnetic field is opposed in the aperture 406. Therefore, the source will not be able to efficiently transfer energy to the device resonator that may be positioned in that aperture 406.

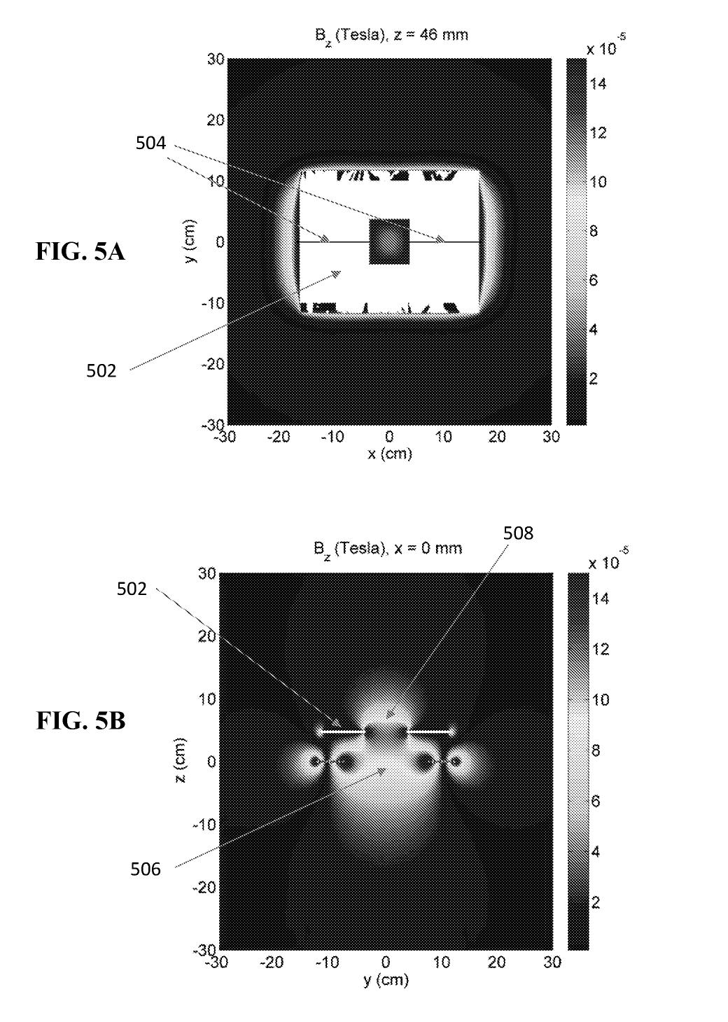

FIGS. 5A-5B show simulations of an exemplary embodiment of a back cover near a source. The back cover shown in this example also uses the properties of aluminum and is made of two continuous pieces (similar to that shown in FIG. 2B). FIG. 5B shows a cross-sectional view of the back cover shown in FIG. 5A. In this case, due to the breaks 504 formed in the back cover 502, the source's magnetic field 506 can reach the device resonator and is further enhanced due to the effect described in FIG. 2B and FIG. 3. In other words, compared to a source resonator transferring energy to a device resonator in free space, the back cover with breaks as shown in FIG. 2B enhances the magnetic field and acts as a repeater at the aperture 508 where the device resonator is to be positioned.

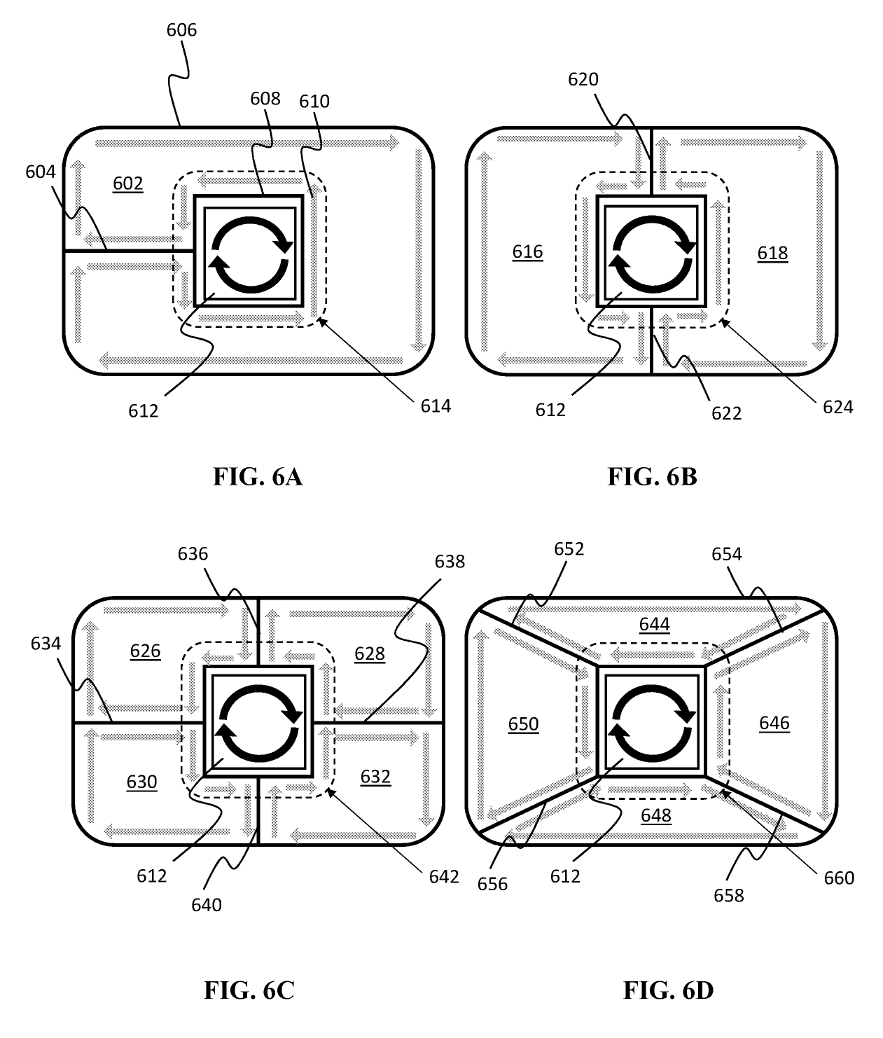

FIGS. 6A-6D show models of exemplary embodiments of back covers of a wirelessly charged computing system. FIG. 6A shows a back cover made of one continuous piece 602 of magnesium alloy. The continuous piece 602 has a single break 604 from the outer edge 606 of the back cover to the inner edge 608 of the back cover. This single break 604 is sufficient to “lead” or provide the lowest impedance path for the eddy current 610 to the inner edge 608 closest to the aperture in which the device resonator 612 resides. This forms the flow of eddy currents within the shape 614. In exemplary embodiments, the aperture 608 may be off-center relative the overall shape of the back cover 606. FIG. 6B shows a back cover made of two continuous pieces 616, 618 of magnesium alloy. Breaks 620, 622 form these two continuous pieces that form a hole or aperture in which resonator 612 resides. By creating these separate pieces around the resonator, the eddy currents are “led” to form around the aperture within the shape 624. FIG. 6C shows a back cover made of four continuous pieces 626, 628, 630, and 632 of magnesium alloy. Breaks 634, 636, 638, and 640 form the four continuous pieces that form a hole or aperture in which resonator 612 resides. The breaks 634, 636, 638, and 640 run fully from the outer edge of the back cover to the inner edge of the back cover. This leads eddy currents to flow within the shape 624 around the inner edge of the back cover. Similarly, FIG. 6D shows a back cover made of four continuous pieces 644, 646, 648, and 650. Breaks 652, 654, 656, and 658 form the four continuous pieces. These breaks run from the outer edge to the inner edge of the back cover at an angle as compared to the breaks shown in FIG. 6C.

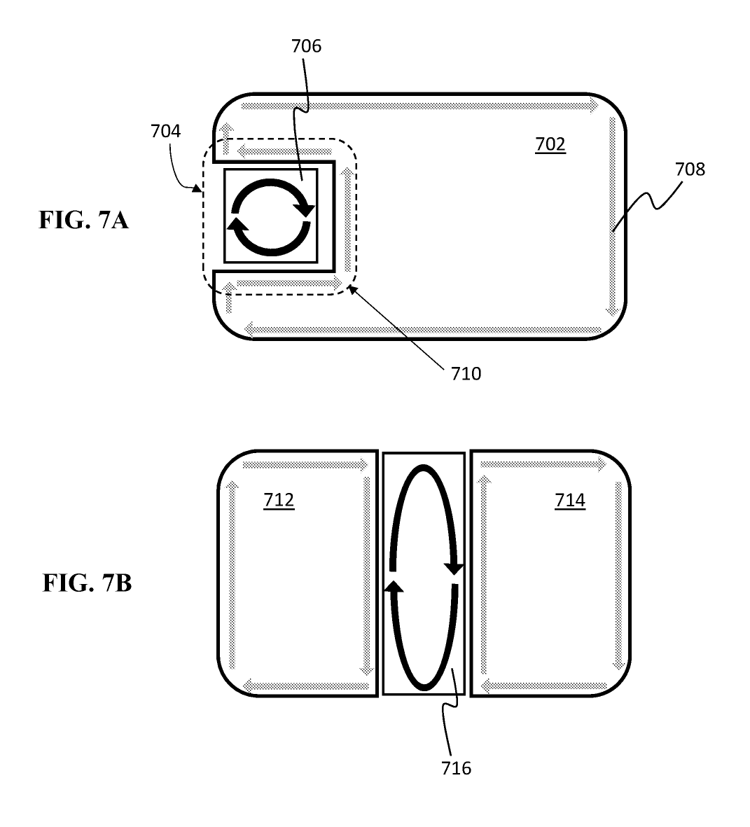

FIGS. 7A-7B show models of exemplary embodiments of back covers for a wirelessly charged computing system. FIG. 7A shows a back cover made of one continuous piece 702 that has a hole 704 on its outer edge that accommodates the size and shape of the resonator fixture 706. The eddy currents 708 travel around three sides of the resonator fixture within the shape 710. This may have a reduced “enhancing effect” than those eddy currents that travel on all four sides of the resonator. FIG. 7B shows a back cover made of two continuous pieces 712, 714 on either side of a resonator fixture 716. This may be used to accommodate a larger resonator that takes up an entire dimension of a back cover as shown. This may have a reduced “enhancing effect” than those eddy currents that travel on all four sides of the resonator. Additionally, it may be important to consider the materials used on the sides of a computing device as the eddy currents may bypass the resonator fixture via the chassis of the computing device. This may result in greater losses.

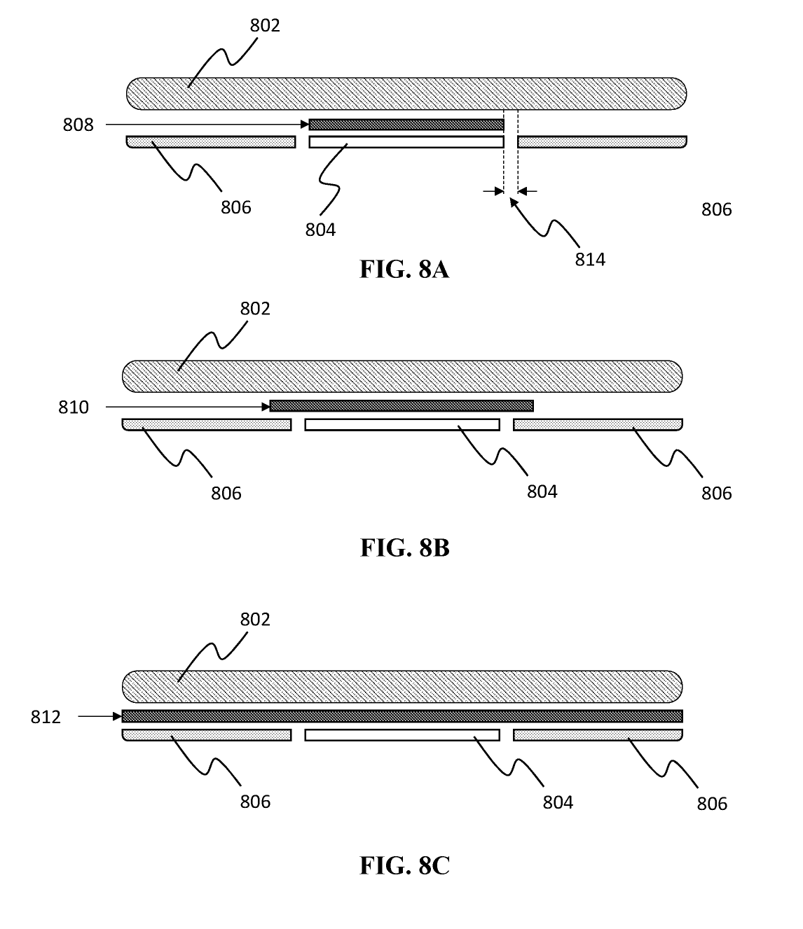

FIGS. 8A-8C show cross-sectional views of exemplary embodiments of wirelessly charged computing devices (not to scale). The wirelessly charged computing device includes a chassis 802, a device resonator 804, the back cover 806, and a layer of magnetic material 808. In embodiments, the magnetic material may be ferrite. In embodiments, the device resonator 804 is flush or in plane with the back cover 806. In FIG. 8A, the magnetic material 808 is confined to the area directly behind resonator 804. In FIG. 8B, the magnetic material 810 is confined to the area behind the resonator 804 and to a portion of the area behind the back cover 806. Thus, the magnetic material 808 overlaps both the back cover 806 and the resonator 804. In FIG. 8C, the magnetic material 812 covers the approximately the area behind the back cover 806 and resonator 804. In exemplary embodiments, the configuration shown in FIG. 8B may be beneficial over the configuration shown in FIG. 8A so that losses in the gap 814 can be prevented. The gap 814 may be large enough such that losses are sustained in a metallic chassis 802 of the computing device. In exemplary embodiments, the configuration shown in FIG. 8C may be beneficial over the configurations shown in FIG. 8A and FIG. 8B so that losses can be further prevented. In embodiments, there may be additional material, such as plastic, acrylic, or polymer, which covers the coil 804 in a protective and/or aesthetic manner. The additional material can also cover the one or more pieces of the back cover 806.

In exemplary embodiments, it may be beneficial for the inductor of the device resonator to be as close as possible (without coming into direct contact) with the inner edge of the back cover so as to be better enhanced by the enhancing effect created by a back cover with breaks, such as that shown in FIG. 2B and FIGS. 6A-6D.

In exemplary embodiments, thermal interface material may be used if there are any “hot spots” that may pose a danger to the computing device's electronics and/or to the user. For example, thermal interface material or another type of material that will be thermally conductive but not electrically conductive may be used in the breaks of the back cover, between the back cover and the magnetic material, between the device resonator and the back cover, etc.

While the disclosed techniques have been described in connection with certain preferred embodiments, other embodiments will be understood by one of ordinary skill in the art and are intended to fall within the scope of this disclosure. For example, designs, methods, configurations of components, etc. related to transmitting wireless power have been described above along with various specific applications and examples thereof. Those skilled in the art will appreciate where the designs, components, configurations or components described herein can be used in combination, or interchangeably, and that the above description does not limit such interchangeability or combination of components to only that which is described herein.

All documents referenced herein are hereby incorporated by reference.

What is claimed is:

1. A wireless power receiver module for a computing system, the wireless power receiver module comprising:
a receiver resonator comprising an inductor formed substantially in a first plane, the receiver resonator is configured to capture oscillating magnetic flux;
a planar piece of metallic material formed in a second plane;
wherein the planar piece of metallic material defines an aperture in which the inductor of the receiver resonator is disposed; and
wherein the planar piece of metallic material defines first and second breaks extending from an outer edge of the planar piece of metallic material to the aperture to form first and second portions of the planar piece of metallic material.

2. The wireless power receiver module of claim 1 wherein the metallic material comprises copper.

3. The wireless power receiver module of claim 1 wherein the planar piece of metallic material defines a third break from the outer edge to the aperture.

4. The wireless power receiver module of claim 1 wherein the planar piece of metallic material defines a fourth break from the outer edge to the aperture.

5. The wireless power receiver module of claim 1 further comprising a layer of magnetic material disposed between a surface of the inductor and the computing system.

6. The wireless power receiver module of claim 5 wherein the layer of magnetic material extends beyond an outer perimeter of the inductor.

7. The wireless power receiver module of claim 6 wherein the layer of magnetic material extends to the outer edge of the planar piece of metallic material.

8. The wireless power receiver module of claim 1 wherein the computing system is a laptop, notebook computer, tablet, or mobile phone.

9. The wireless power receiver module of claim 1 wherein the planar piece of metallic material forms a back cover of the computing system.

10. The wireless power receiver module of claim 1 wherein the aperture is rectangular and wherein the breaks in the planar piece of metallic material extend to respective locations on different edges of the rectangular aperture.

11. The wireless power receiver module of claim 1 wherein the breaks in the planar piece of metallic material are formed at an angle to the aperture.

12. The wireless power receiver module of claim 1 wherein the planar piece of metallic material enhances coupling between the receiver resonator and a source resonator configured to generate an oscillating magnetic field when the receiver resonator is positioned over the source resonator.

13. The wireless power receiver module of claim 1 wherein thermal interface material is positioned in the breaks of the planar piece of metallic material.

14. The wireless power receiver module of claim 1 wherein the first plane and second plane are coplanar.

15. The wireless power receiver module of claim 1 wherein the breaks in the planar piece of metallic material have a width equal to or greater than 0.05 mm.

16. The wireless power receiver module of claim 1 wherein the first portion is configured to confine a first eddy current and the second portion is configured to confine a second eddy current when the module is positioned near a wireless power source providing an oscillating magnetic field.

17. A method comprising:
forming a first break and a second break in a planar piece of metallic material such that the first and second breaks extend from an outer edge of the planar piece of metallic material to an aperture defined in the planar piece of metallic material, wherein the planar piece of metallic material is in a first plane and wherein the first and second breaks form a first portion and a second portion of the planar piece of metallic material; and
disposing an inductor of a receiver resonator in the aperture in a second plane.

18. The method of claim 17 comprising forming a third break in the planar piece of metallic material such that the third break extends from the outer edge to the aperture.

19. The method of claim 17 comprising forming a fourth break in the planar piece of metallic material such that the fourth break extends from the outer edge to the aperture.

20. The method of claim 17 wherein the first portion confines a first eddy current and the second portion confines a second eddy current when the module is positioned near a wireless power source providing an oscillating magnetic field.
